(19) United States
(12) Patent Application Publication
(10) Pub. No.: US 2013/0327935 A1
(43) Pub. Date: Dec. 12, 2013

(54) METHOD AND DEVICE FOR INCREASING THE THROUGHPUT IN TIME-OF-FLIGHT MASS SPECTROMETERS

(71) Applicant: Michael Wiedenbeck, Potsdam (DE)

(72) Inventor: Michael Wiedenbeck, Potsdam (DE)

(73) Assignee: HELMHOLTZ-ZENTRUM POTSDAM DEUTSCHES GEOFORSCHUNGSZENTRUM - GFZ STIFTUN DES ÖFFENTLICHE, Potsdam (DE)

(21) Appl. No.: 14/001,520

(22) PCT Filed: Feb. 24, 2012
(86) PCT No.: PCT/EP2012/053217

§ 371 Date: Aug. 26, 2013

(30) Foreign Application Priority Data
Feb. 25, 2011 (DE) 10 2011 004 725.5

(51) Int. Cl. H01J 49/40; H01J 49/00

(52) U.S. Cl. CPC H01J 49/40; H01J 49/0031
USPC 250/282; 250/287

(57) ABSTRACT

The invention relates to a method for increasing the throughput in time-of-flight mass spectrometers as well as a device for conducting the method.

The invention relates to a method for increasing the throughput in time-of-flight mass spectrometers, whereby the individual ion packets 5, which the extractor 2 admits into the drift zone 4, are deflected inside the drift zone by means of deflecting devices 6 disposed in the drift zone for the generation of time-variable electric fields, whereby the measurement of the deflection is such that the site where the deflected ion packet 5 strikes the detector 3 can be assigned by means of the detector 3, and the deflection is detected as additional information together with the flight time by means of the detector 3, whereby for each ion packet 5, the intensity of the electric field is selected such that the intensity of the electric field does not coincide with the one which was selected for the ion packet that was previously admitted from the extractor 2 into the drift zone 4.

The invention relates to a method for increasing the throughput in time-of-flight mass spectrometers as well as a device for conducting the method.

Time-of-flight mass spectrometry (TOF-MS) is a well-established spectroscopic method for the chemical characterization of substances. TOF-MS uses a pulsed ion source, which is used in great variety in research and production. Simply represented, TOF-MS comprises the following steps for the separation of masses and the recording of the mass spectrum:

1. Injection of the ionized sample within a short time segment (sub-μsec).

2. Transport of the ions through a pre-determined drift zone (flight path).

3. Ion detection by means of highly precise determination (sub-μsec) of the flight time by means of a pulse-counting ion detector.

The most important advantages of TOF-MS in comparison to other spectroscopic methods are:

1. Simultaneous determination of masses over a wide region of masses, it being possible to find the important parameters and to evaluate these only after successful measurement.

2. Good to excellent mass resolution.

3. High permeability, since nearly all ions entering into the device can also be detected.

4. Compact design without the necessity of having to use magnets.

4*. Favorable costs for operation and acquisition in comparison to sector-field mass spectrometers. *sic; 5?—Translator's note.

Despite the many advantages when compared to other mass-spectrometric methods, however, TOF-MS has one large disadvantage. TOF-MS is relatively slow with respect to the data acquisition rate. This problem is based on the fact that the ions require a finite time to migrate through the drift zone and to reach the detector. During this time, for example, care must be taken that lighter, thus faster ions of a later pulse do not overtake the heavier, thus slower ions still migrating in the drift zone. This problem is currently solved in that TOF-MS extends waiting times until no ions are admitted into the drift region. This, however, leads to long waiting times, which introduces inefficiency in the measurement system. Other solutions to the problem are known, but lead to clearly reduced mass resolution or to a reduction of the optimal mass range that can be detected. These solutions are thus unacceptable for many practical applications.

Various solutions to the above-named problems have been described in the prior art. Thus, in U.S. Pat. No. 6,521,887 B1, a continuous ion beam is recorded in a time-resolved manner after a continuous two-dimensional deflection with a two-dimensional detector. It is a disadvantage in this case that the evaluation is very complex and many ambiguities arise in the interpretation due to the space-time superimposition. US 2008/0001080 A1 teaches the variable deflection of the direction of flight for the different ions of the individual ion packet by the deflection pulse, in order to also make possible a differentiation according to the ion mass in addition to the differentiation in the ion velocity. The waiting times, however, are not shortened thereby. In US 2004/0119012 A1, two or more individual detectors are used, which do not operate in a spatially resolved manner, and are disposed at different sites in the beam path.

Spectrometers of this type are also known from EP 1,737,018 A2, and involve a spectrometer in which a spatially extended detector is disposed parallel to the main direction of flight of the ions. The spectrometers according to US 2008/0272289 A1 and WO 2007/106449 A2, however, do not have spatially or time-resolved detectors. The problem of the small throughput is thus not solved thereby.

The object of the present invention is to overcome the disadvantages of the prior art and to shorten the TOF-MS waiting times.

The object is achieved by a method that has the features of the principal claim. Advantageous embodiments of the method according to the invention are characterized in the dependent subclaims.

The object is further achieved by a device, especially a time-of-flight mass spectrometer that has the features of the independent device claim. Advantageous embodiments of the device according to the invention are characterized in the dependent device subclaims.

The object is achieved by a method for increasing the throughput in time-of-flight mass spectrometers, whereby the individual ion packets that the extractor admits into the drift zone are deflected inside the drift zone by means of at least one deflecting device disposed in the drift zone, for the generation of electric fields that are variable in time and intensity, and the deflection is detected as additional information together with the flight time of the ions by means of a detector.

An ion packet in the sense of the invention is an accumulation of ions that will be separated by means of the spectrometer according to their mass. The ion packet thus represents an aliquot of the sample to be investigated.

In the sense of the present invention, deflection is understood to be the discrete change in the direction of flight of the ions to the detector. Since the deflection is only a type of pulse and thus acts only over the time period in which the ion packet moves through the deflecting device, the ions then again follow a straight flight path, whose point of impact on the detector is determined in advance as a function of the strength of the deflection, thus of the applied electric field.

The subject of the invention is a method for increasing the throughput in time-of-flight mass spectrometers, whereby individual ion packets are admitted one after the other into the drift zone by means of the extractor, and then each individual ion packet is deflected by means of electric fields that are variable in time and intensity and disposed in the drift zone, and in fact deflected in such a way that the respective ion packet is subjected to an electric field that is different than that of the ion packet that is admitted into the drift zone before it or after it, and whereby the intensity of the electric field is not changed during the deflection of an ion packet.

It is preferred according to the invention that the electric field is selected such that the site at which the deflected ion packet strikes the detector is determined in advance. Thus, each of the successive ion packets is deflected in such a way that, after passing through the drift zone, it then strikes a predetermined part of the detector surface and is then recorded, with time and site resolution, by the detector.

In addition, it is particularly preferred that the time variability of the electric field is matched with the admission control of the extractor. This matching ensures that the successive individual ion packets which are generated by the extractor and admitted from the extractor into the drift zone and the deflection run synchronously, and each of the individual ion packets is deflected in total in each case in a specific direction.

It is also preferred that the intensity of the electric field is selected such that a pre-determined deflection is ensured for each individual ion packet.

A method is also preferred, whereby, within the drift zone, the electric field acts on the ion packets in the direct vicinity of the extractor, and electric fields do not act in the further course of the drift zone. This means that the at least one deflecting device is disposed only at the start, thus in the spatial vicinity of the extractor, and electric fields that bring about a deflection according to the invention do not operate in the further course of the drift zone.

A method is preferred, whereby the deflecting device generating the electric field is disposed along the x or y-axis or along the x and y-axes, the z-axis running in the direction of the drift zone.

A method is particularly preferred, whereby the deflecting device generating the electric field is disposed in different regions of the drift zone along the x-axis and the y-axis.

A method is further preferred, whereby the intensity of the electric field is selected such that a change in site for the impact on the detector can be resolved for the detector.

In addition, a method is preferred, whereby the start time of the respective ions is determined by means of the site in the detector where the ions strike. This means that the start time of the ions can be determined by means of the impact coordinates in the detector.

The person skilled in the art can easily conduct the method according to the invention by means of appropriate software. When the spectra are recorded, the appropriate time stamp is to be assigned to the ions and then the spectrum is to be resolved correspondingly. Calculation methods of this type are known to the person skilled in the art. This means that there is a clear time stamp for the input of the ions from the ion source.

The object is further achieved by a device for conducting a method according to the invention, composed of an acceleration zone and an essentially field-free drift zone, whereby these zones are disposed sequentially between an ion source for generation of the ions to be investigated and a detector for the detection of the ions to be investigated, and whereby at least one deflecting device that deflects the ions is disposed in the region of the field-free drift zone for the ions to be investigated, which deflects the ions in such a way that these ions no longer drift through the origin relative to the x-coordinate, y-coordinate or x-y coordinates in the drift zone, the z-axis running along the direction of the drift zone, and whereby the measurement of the deflection varies in time.

Also, a device is preferred, in which the deflecting device is disposed in the direct vicinity of the extractor.

A device is particularly preferred, whereby the detector is designed in such a way so as to determine the deflection of the ions to be investigated, the deflection being able to be produced by the deflecting device relative to the x-y flight path, which is given by the x-y-coordinates, within the drift zone.

Also, a device is preferred, whereby the deflecting device comprises a pair of plates disposed parallel to one another, and a difference in electric potential can be applied between these plates.

Deflecting devices of this type, however, may also be other devices known to the person skilled in the art. In particular, quadrupoles, sextupoles and the like are included for this purpose.

In this case, it is particularly preferred that the deflecting device comprises a second pair of plates disposed parallel to one another, which are disposed shifted by 90° relative to the first pair of plates, whereby a difference in electric potential can be applied between the second pair of plates.

In addition, it is particularly preferred in this case that the potential difference between the first pair of plates and the second pair of plates is the same or different.

A device is also preferred, whereby the pair of plates is disposed at the start of the drift zone.

In addition, according to the invention, it is preferred that the device is characterized in that the second pair of plates is disposed essentially in the same region as the first pair of plates within the drift zone, or that the second pair of plates is distanced from the first pair of plates in such a way that it is disposed in the further course of the drift zone.

The voltages or potentials that are applied to the plates or to other suitable deflecting devices may each have the same absolute magnitude but differ in sign, in the case of plates. It is also possible to apply potentials with the same sign, but different magnitudes. Polarity and magnitude of the applied voltages and potentials are dependent on the type of construction of the spectrometer used. The optimal values may be determined in a simple way by the person skilled in the art.

Therefore, in order to solve the problem, it is provided to assign to each ion packet a time stamp, which is present in the form of a deflection voltage that is applied to the ion-optics system. In this way, the path of the ion packet through the drift zone is modified. By means of suitable technology, which permits the assignment of the detected ions to the corresponding x-y coordinates, the time stamp can be determined and the ion packet can be assigned to the corresponding sample.

The deflection voltages, which are used for the method according to the invention are advantageously step-form variable d.c. voltages. In this case, it is advantageous that the voltage changes are produced rapidly so that the newly selected voltage is stable before the next pulse is active, which then will deflect a further ion packet.

The region in which the deflection of the ion packets takes place occupies only a small region of the entire flight zone. This is important, since the ion packets should still not be separated when the time stamp is given to them in the form of the deflection from the flight path. The deflection will only be configured as a deflection pulse. It is not provided to further influence the ions in the drift zone by means of electric fields that represent a deflection in the form of a time stamp.

The time stamp, which is assigned to an ion packet, is then determined by the detector. For this purpose, known technology is used, which permits a precise assignment of the x-y-coordinates and the arrival time of the respective ion in the detector. By means of the determination of the x-y-coordinates of the arrival of an ion in the detector, it is possible to assign the measured ion to an extraction pulse whose precise extraction time is known. In this way, an improvement of the throughput by a factor of 10 to 100 or more is made possible. In this case, adverse effects on the entire system do not occur, even if appropriate deflecting devices need to be incorporated in the design of the spectrometer for this purpose. The actual improvement in the throughput or, in other words, the number of operating cycles, depends on the discrete potential differences or applied voltages in the deflecting device. In addition, the detector also must be able to resolve the respective deflections of the flight paths. In a simple example, if one starts with a deflecting device which applies discrete voltages in the form of a 3×3 deflection matrix, then an improvement of the data acquisition rate by a factor of 9 is achieved. Such an increase in the data acquisition rate is particularly advantageous for systems that will detect transient signals such as is the case in a GC-MS coupling.

The invention will be explained in more detail on the basis of the appended figures.

Herein:

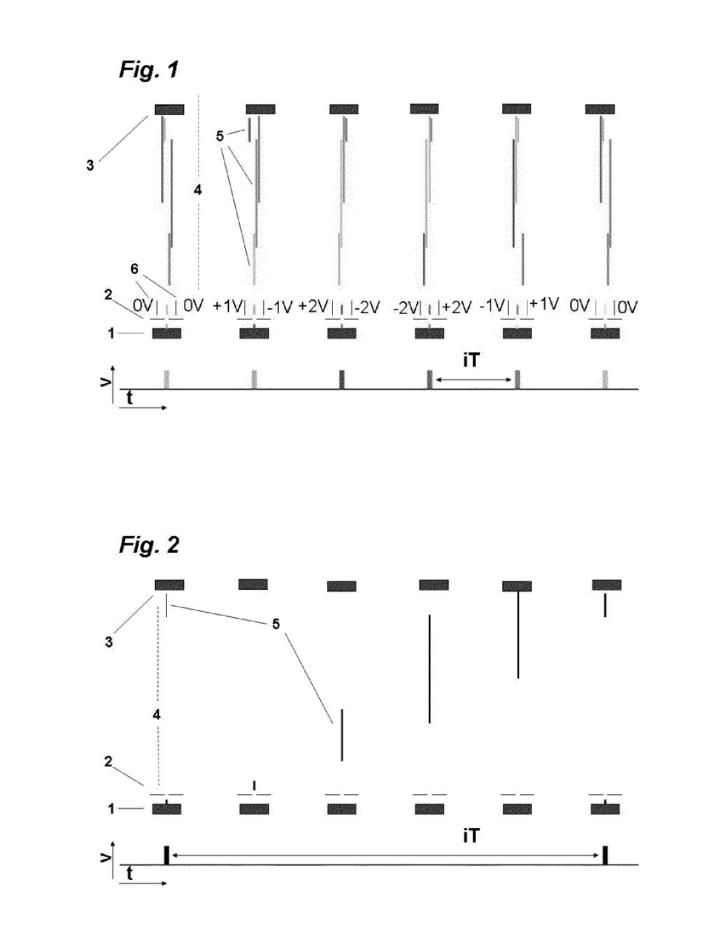

FIG. 1 shows a time-of-flight mass spectrometer according to the invention at different time points in the operation;

FIG. 2 shows a time-of-flight mass spectrometer according to the prior art at different time points of the operation, and

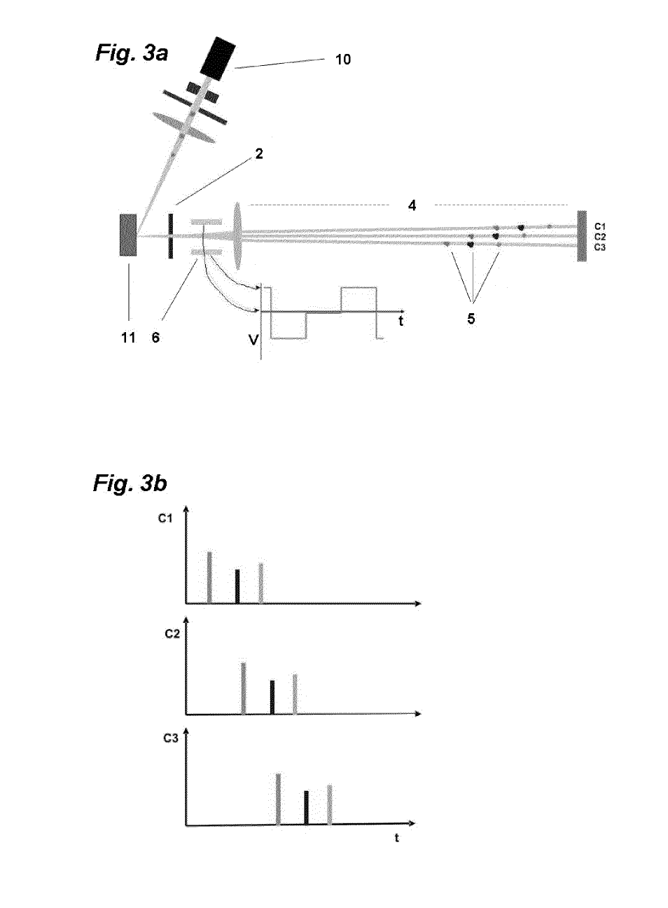

FIG. 3 with figure parts a and b shows a time-of-flight mass spectrometer according to the invention as well as spectra produced therewith.

FIG. 1 shows a time-of-flight mass spectrometer according to the invention at different time points in the operation. Six different time points along the time axis t are shown. A discrete deflection is given for the respective ion packets to be measured at each of the time points t. From the ion source 1, the ion packets 5 to be investigated are introduced into the field-free drift zone 4 by means of the extractor 2. The ion packets then strike the detector 3 and are then detected relative to the time of impact. Between two successive measurements, the extractor 2 prevents further ion packets 5 from reaching drift zone 4, since otherwise, faster, i.e., lighter ions could overtake the slower and heavier ions from the preceding ion packet. A deflecting device 6 is now disposed in the region of the drift zone 4. This deflecting device 6 is shown in FIG. 1 as an arrangement of plates that can have different electric potentials. In FIG. 1 these are denoted by 0 V, −1 V, −2 V, +1 V and +2 V, each time depending on time point t. According to the arrangement of the plates in FIG. 1, the ion packets can now be deflected on the detector along a spatially modified flight path. In the present case, five discrete deflection values in the x-axis are possible for the named potential values. This means that the waiting time iT, i.e., the time that has to pass between two successive start signals from the extractor 3 so that the ions of successive packets do not interfere with one another, is reduced to one-fifth of the waiting time that is necessary for the system according to the prior art.

FIG. 2 now shows a time-of-flight mass spectrometer according to the prior art for this purpose at different time points of the operation. A time-of-flight mass spectrometer that does not have a deflecting device is shown in FIG. 2. In FIGS. 1 and 2, the time axis t and the field axis V have the same scaling. The waiting time, thus the time that must pass between two successive measurements so that the two successive ion packets do not interfere with one another is essentially longer for the time-of-flight mass spectrometer according to the prior art. This long waiting time is the principal disadvantage of the time-of-flight mass spectrometer according to the prior art.

If the waiting times in FIG. 1 and in FIG. 2 are now compared, it is clear that in the time-of-flight mass spectrometer according to the present invention this waiting time amounts to only one-fifth the waiting time according to the prior art.

The waiting time can be reduced still further as a function of the potentials that are applied to the deflecting device 6. The respective potential differences must be selected such that deflections result therefrom that can be appropriately resolved by the detector 3.

By way of example, the deflection along the x-axis is shown in FIG. 1. It is provided, however, according to the invention to carry out the deflection additionally also in the direction of the y-axis. There thus results in the present case a 5×5 deflection matrix, thus 25 discrete x-y values, by which the ion packets 5 can strike the detector 3. In this case, the waiting time would be reduced to one-twenty-fifth of the waiting time according to the prior art.

A time-of-flight mass spectrometer according to the invention is shown in FIG. 3 with figure parts a and b. FIG. 3a is considered first. Ions that are pulsed and focused as needed in advance are directed from the ion gun 10 onto a target 11, from which the ion packets 5 to be investigated are then generated. Now, individual ion packets are admitted into the drift zone 4 by means of the extractor 2 and are separated therein. Prior to admission into the drift zone 4, the respective ion packet 5 is deflected from the direction of flight by means of the deflecting device in such a way that it then continues inside the drift zone, which leads to the circumstance that the ions of this packet strike a pre-determined site on the detector. A diagram that shows the voltage applied to the deflecting device 2 over time is depicted in the lower portion of FIG. 3a. It can be recognized from the diagram that the deflection voltage is applied in the shape of a rectangular voltage and remains at a pre-determined voltage as long as the respective ion packet stays in the region of the deflecting device. Thus, each ion packet is deflected only with a specific voltage. The subsequent ion packet is then deflected by a different voltage and then consequently strikes the detector at another site in the detector. This is clearly shown for three ion packets in FIG. 3a. These three ion packets strike the detector at C1, C2 and C3. The respective spectra of the three separated ion packets are now shown in FIG. 3b. FIG. 3b shows the advantage of the method according to the invention in that an additional spectrum C2 can be recorded, although it overlaps in time with the spectra of the previously and of the subsequently emitted ion packets. Without the method according to the invention of the deflection of the ion packet, which is controlled over time, it would only be possible to record the spectra C1 and C3 with the mass spectrometer without overlapping on the same site of the detector. By means of the deflection of the ion packets, however, the overlapping of the spectra in the detector is avoided, so that in the present case, another spectrum C2 can be recorded. It is now clear that the number of additional spectra that can be measured within the otherwise usual waiting time iT can be considerably increased by the strength of the deflection of the respective ion packets. This leads to the increase of the throughput according to the invention for spectrometers of this type.

### LIST OF REFERENCE CHARACTERS

1 Ion source
2 Extractor
3 Detector
4 Drift zone
5 Ion packet(s)
6 Deflecting device
Ion gun
Target
t Time
V Voltage
iT Waiting time

1. A method for increasing the throughput in time-of-flight mass spectrometers, wherein
the individual ion packets, which the extractor admits into the drift zone, are deflected inside the drift zone by means of at least one deflecting device disposed in the drift zone, for the generation of electric fields that vary in time and intensity, and
the deflection is detected as additional information together with the flight time of the ions by means of a detector.

2. The method according to claim 1, further characterized in that the electric field is selected such that the site at which the deflected ion packet strikes the detector is pre-determined.

3. The method according to claim 1, further characterized in that the time variability of the electric field is coordinated with the admission control of the extractor.

4. The method according to claim 1, further characterized in that the intensity of the electric field is selected such that a pre-determined deflection is ensured for each individual ion packet.

5. The method according to claim 1, further characterized in that the electric field acts on the ion packets within the drift zone in the direct vicinity of the extractor, and electric fields do not act in the further course of the drift zone.

6. The method according to claim 1, further characterized in that the deflecting device that generates the electric field is disposed along the x or y-axis or along the x and y-axes, the z-axis running along the direction of the drift zone.

7. The method according to claim 6, further characterized in that the deflecting device that generates the electric field is disposed along the x-axis and the y-axis in different regions of the drift zone.

8. The method according to claim 1, further characterized in that the intensity of the electric field is selected such that the site change for striking the detector can be resolved for the detector.

9. The method according to claim 1, further characterized in that the start time of the respective ions is determined by means of the site in the detector where the ions strike.

10. A device for conducting a method according to claim 1, composed of an acceleration path and an essentially field-free drift zone, whereby these zones are disposed successively between an ion source for generation of the ions to be investigated and a detector for the detection of the ions to be investigated, and whereby at least one deflecting device for the ion packets to be investigated is disposed in the region of the drift zone, this device deflecting the ion packets in such a way that they no longer need to drift through the origin relative to the x-coordinate, y-coordinate or x-y-coordinates in the drift zone, the z-axis running along the direction of the drift zone, and whereby the measurement of the deflection is time-variable.

11. The device according to claim 10, further characterized in that the deflecting device is disposed in the direct vicinity of the extractor.

12. The device according to claim 10, further characterized in that the detector is designed so as to determine the deflection of the ions to be investigated, this deflection being able to be produced by the deflecting device, relative to the x-coordinate, y-coordinate or x-y-coordinates within the drift zone.

13. The device according to claim 10, further characterized in that the deflecting device comprises a pair of plates disposed parallel to one another, and a difference in electric potential can be applied between these plates.

14. The device according to claim 13, further characterized in that the deflecting device comprises a second pair of plates disposed parallel to one another, this second pair being disposed shifted by 90° relative to the first pair of plates, whereby a difference in electric potential can be applied between the second pair of plates.

15. The device according to claim 14, further characterized in that the potential difference between the first pair of plates and the second pair of plates is the same or is different.

16. The device according to claim 13, further characterized in that the pair of plates is disposed at the start of the drift zone.

17. The device according to claim 14, further characterized in that the second pair of plates is disposed essentially in the same region as the first pair of plates within the drift zone or that the second pair of plates is distanced from the first pair of plates in such a way that this pair is disposed in the further course of the drift zone.
